(19) United States
(12) Patent Application Publication
(10) Pub. No.: US 2025/0113162 A1
(43) Pub. Date: Apr. 3, 2025

(54) VEHICLE-FUNCTION MANAGEMENT DEVICE

(71) Applicant: SUBARU CORPORATION, Tokyo (JP)

(72) Inventors: Hisataro IINAMI, Tokyo (JP); Yusuke KOMATSU, Tokyo (JP); Hironori OOSHIMA, Tokyo (JP); Kenji KANIWA, Tokyo (JP); Takuya YOKOHASHI, Tokyo (JP); Akihisa WADA, Tokyo (JP); Tatsuro YAMASAKI, Tokyo (JP)

(21) Appl. No.: 18/979,850

(22) Filed: Dec. 13, 2024

Related U.S. Application Data
(63) Continuation of application No. PCT/JP2023/028947, filed on Aug. 8, 2023.

(51) Int. Cl. H04W 4/021; H04L 9/32; H04W 4/029

(52) U.S. Cl. CPC H04W 4/021; H04L 9/3263; H04W 4/029

(57) ABSTRACT

A vehicle-function management device includes one or more processors and a storage medium storing a program. The program includes one or more instructions that cause the one or more processors to acquire certificate data including contents of a function's setting of a vehicle in a specific area and effective-distance information regarding a change of the function's setting, acquire positional information of the vehicle, determine a position of the vehicle by short-range wireless communication, change the function's setting in accordance with the contents of the function's setting in the certificate data when it is determined that the vehicle is in the specific area designated by the certificate data, and terminate a state in which the function's setting has been changed when a travel distance of the vehicle in a state in which the function's setting has been changed exceeds a travel distance indicated by the effective-distance information.

### CROSS-REFERENCE TO RELATED APPLICATIONS

This application is continuation of International Application No. PCT/JP2023/028947, filed on Aug. 8, 2023, the entire contents of which are hereby incorporated by reference.

### BACKGROUND

The disclosure relates to a vehicle-function management device that performs control relating to various functions of a vehicle.

Japanese Unexamined Patent Application Publication No. 2011-168274 mentioned below discloses a technology for controlling a speed limit of a vehicle to be equal to or higher than an initial set value when the position of the vehicle is within a function restriction release area.

### SUMMARY

An aspect of the disclosure provides a vehicle-function management device configured to be applied to a vehicle. The vehicle-function management device includes one or more processors and a storage medium. A program to be executed by the one or more processors is stored in the storage medium. The program includes one or more instructions. The one or more instructions are configured to cause the one or more processors to perform; a certificate acquisition process of acquiring certificate data comprising a content of a function's setting of the vehicle in a specific area and effective-distance information regarding a change of the function's setting of the vehicle; a positional-information acquisition process of acquiring positional information of the vehicle; a position determination process of determining a position of the vehicle by short-range wireless communication; a function setting process of making a change to the function's setting of the vehicle in accordance with the content of the function's setting in the certificate data when it is determined, based on the positional-information acquisition process and the position determination process, that the vehicle is in the specific area designated by the certificate data; and a process of terminating a state in which the function's setting of the vehicle has been changed through the function setting process when a travel distance of the vehicle in a state in which the function's setting has been changed exceeds a travel distance indicated by the effective-distance information.

### BRIEF DESCRIPTION OF THE DRAWINGS

FIG. 1 is a diagram illustrating a configuration relating to a vehicle-function management device of an embodiment of the disclosure;

FIG. 2 is a diagram illustrating certificate data of the embodiment;

FIG. 3 is a diagram illustrating a process relating to changing a setting of a function of the embodiment;

FIG. 4 is a flowchart of an example of a process to be performed by the vehicle-function management device of the embodiment; and

FIG. 5 is a flowchart of an example of a process to be performed by the vehicle-function management device of the embodiment.

### DETAILED DESCRIPTION

For example, it is preferable that a speed limiter or the like can be deactivated in a specific area such as a circuit or a test course for vehicle driving. Accordingly, it seems to be beneficial to change a function (e.g., to disable a speed limiter function) when it is determined that a vehicle is within a specific area in accordance with, for example, positional information acquired by a global navigation satellite system (GNSS).

However, there is a spoofing attack method against a GNSS receiver of a vehicle, posing a risk of tampering with positional information. In addition, the accuracy of the positional information may be compromised due to weather or topography. Thus, there is a possibility that appropriate function settings cannot be performed for each area.

It is desirable to be capable of more appropriately making changes to settings of various functions.

In the following, an embodiment of the disclosure is described in detail with reference to the accompanying drawings. Note that the following description is directed to an illustrative example of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiment which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description.

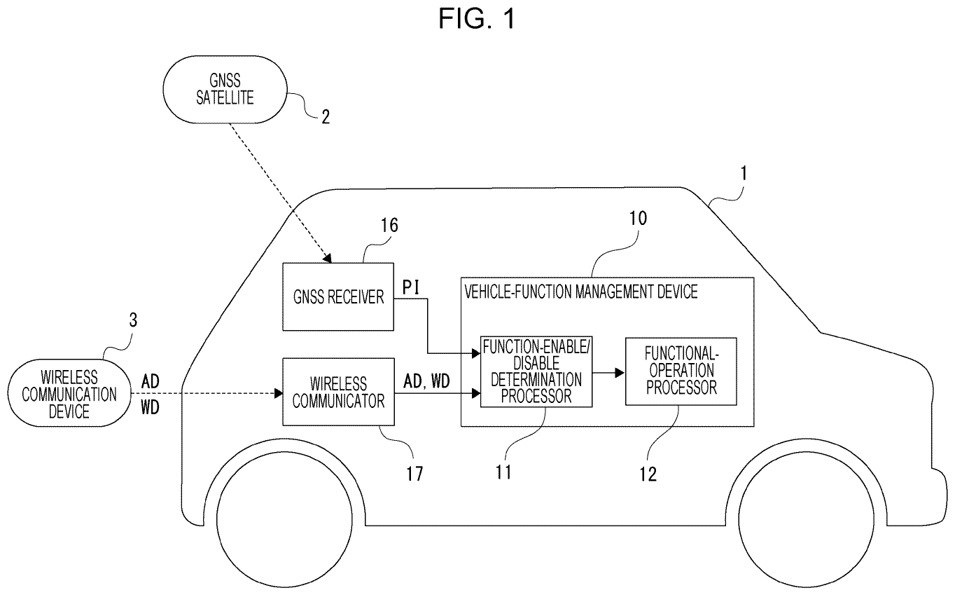

FIG. 1 illustrates a vehicle 1 equipped with a vehicle-function management device 10 of the embodiment.

The vehicle 1 includes the vehicle-function management device 10, one or more functional units 15, a GNSS receiver 16, and a wireless communicator 17.

Note that FIG. 1 illustrates only some of the components of the vehicle 1, and it is obvious that the vehicle 1 includes various components for traveling.

The vehicle-function management device 10 includes one or more processors. More specifically, the vehicle-function management device 10 is constituted by one or more electronic control units (ECUs) in the vehicle 1. The ECUs may include various ECUs such as a traveling control ECU, a battery control ECU, an engine control ECU, a display control ECU, a driving support ECU, an automatic driving ECU, and an air conditioning control ECU. The vehicle-function management device 10 may be configured constituted by any of these ECUs in the vehicle or an ECU dedicated to a function of the present embodiment.

The vehicle-function management device 10 includes a central processing unit (CPU), a read only memory (ROM), a random access memory (RAM), a non-volatile memory, an input/output interface, and the like. The CPU executes various processes in accordance with programs stored in the ROM and the non-volatile memory. The RAM appropriately stores data and the like that are necessary for the CPU to execute the various processes.

Functions of a function-enable/disable determination processor 11 and a functional-operation processor 12 illustrated in FIG. 1 are implemented by programs run by the CPU.

The function-enable/disable determination processor 11 performs a determination relating to enabling or disabling a function in a specific area on the basis of the current position of the vehicle 1 and certificate data, which will be described later.

The functional-operation processor 12 controls the actual changes of settings of various functions on the basis of the determination performed by the function-enable/disable determination processor 11.

Examples of the functions whose settings are to be changed by the functional-operation processor 12 include the following.
speed limiter function
anti-lock braking system (ABS) function
steering assist function
driving support function
data logging function:
accelerator-map change function
valet key mode

The speed limiter function, the ABS function, the steering assist function, the driving support function, and the like may sometimes be desired to be disabled in, for example, a circuit, a test course, or the like. The accelerator-map change function and the data logging function may sometimes be desired to be enabled in a circuit, a test course, or the like.

Note that the data logging function is a function of logging information obtained by various sensors such as, for example, an oil pressure sensor, an oil temperature sensor, an acceleration sensor, an accelerator opening sensor, a traveling positional information sensor, and a braking sensor that are included in the vehicle 1. By enabling the data logging function, a traveling history of the vehicle 1, a driving history of a driver who drives the vehicle 1, and the like can be recorded, and they can be, for example, displayed or analyzed later.

The valet key mode is a type of security function and is a function of, for example, turning off a display of a navigation system or restricting a traveling area by being enabled. For example, when the vehicle 1 is left with someone at a facility, such as a hotel, this function prevents the navigation system from being used, thereby preventing the home address from being revealed or preventing the vehicle 1 from being stolen. Thus, the valet key mode may sometimes be desired to be enabled in an area within the premises of, for example, a hotel.

The above-described functions are examples, and the various functions in the vehicle 1 may be enabled or disabled, or their contents may be changed.

Actually, it is determined, on the basis of the description in certificate data AD (described later), which function undergoes a setting change in which area.

The settings of these various functions are performed by the respective ECUs in charge of each function. Thus, the functional-operation processor 12 performs a control process of enabling or disabling each function through communication with the one or more ECUs in the vehicle 1.

The vehicle-function management device 10, which makes such changes to the settings of the functions, receives positional information PI from the GNSS receiver 16 and receives the certificate data AD and position determination data WD from the wireless communicator 17 in order to make appropriate changes to the settings.

The GNSS receiver 16 receives a signal from a GNSS satellite 2 and transmits the positional information PI to the vehicle-function management device 10.

Accordingly, the function-enable/disable determination processor 11 in the vehicle-function management device 10 can determine the current position of the vehicle 1.

The wireless communicator 17 performs wireless communication with a wireless communication device 3 that is installed in a specific area such as, for example, a circuit. In this case, the wireless communication device 3 is a device for short-range wireless communication, which is communication that can be performed only within a specific area such as, for example, within a circuit.

Specific examples of the wireless communication device 3 include a vehicle-to-roadside-infrastructure (V2I) roadside unit, a 5G-new radio (5G NR) base station, and a local Wi-Fi hotspot, and the wireless communicator 17 is a communication device that is compatible with them.

The V2I is road-to-vehicle communication in which a device that supports V2I and that is installed on a road and an automobile communicate with each other and is a system in which wireless communication is performed in a limited range by using a high-frequency band as it is used in, for example, an electronic toll collection (ETC) system.

The 5G NR also enables wireless communication in a relatively narrow area by using a high-frequency band.

The wireless communicator 17 in the vehicle 1 communicates with the wireless communication device 3 by these short-range wireless communication methods and receives the position determination data WD and the certificate data AD.

The position determination data WD may be any data as long as it can determine that the vehicle 1 is present in a specific area. For example, the position determination data WD may be an identification code of the wireless communication device 3 serving as a roadside unit, identification information of a facility such as a circuit, or the like. In other words, the position determination data WD is data that can determine the presence of the vehicle 1 in the specific area if the vehicle 1 can communicate with a roadside unit or the like. In addition, the position determination data WD may be positional information of the wireless communication device 3.

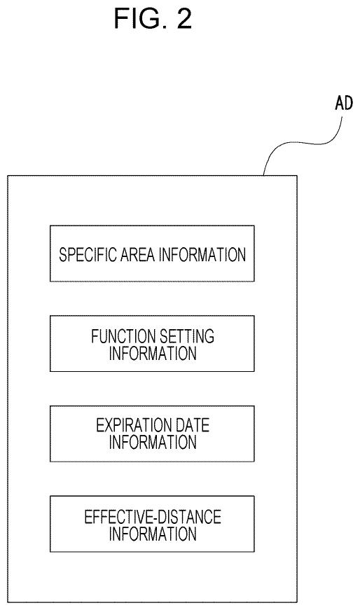

The certificate data AD is data in which information relating to changes of the settings of the various functions in the specific area is described. A conceivable example of the certificate data AD is certificate data that includes contents such as those illustrated in FIG. 2 by using the extension area of the X.509 certificate.

For example, in the certificate data AD, specific area information, function setting information, expiration date information, effective-distance information, and the like are described. Note that these are examples, and it is not necessary for the certificate data AD to include all of these contents, and the certificate data AD may include other contents.

Examples of the specific area information include information regarding a facility such as a circuit track or a test course, identification information for identifying a specific area of the facility, positional information indicating a range of the specific area to which this certificate is applied, and the like.

The function setting information is information indicating a function whose setting can be changed in this area. For example, the function setting information is information indicating that the speed limiter function may be disabled in this circuit.

The expiration date information is information indicating a time limit within which a change made to a setting of a function can be maintained in accordance with this certificate.

The effective-distance information is information indicating a limit of a travel distance in which a change made to a setting of a function can be maintained in accordance with this certificate.

For example, when the certificate data AD having such contents is issued for one specific area, the vehicle 1 that has received the certificate data AD can change, in the specific area, a setting of a function within the range of the contents indicated in the certificate data AD.

The vehicle-function management device 10 receives the positional information PI from the GNSS receiver 16 and receives the certificate data AD and the position determination data WD, which have been received by the wireless communicator 17, and the function-enable/disable determination processor 11 determines what type of function setting change is possible.

In this case, the function-enable/disable determination processor 11 uses not only the positional information PI but also the position determination data WD so as to determine with high accuracy whether the vehicle 1 is currently located in the specific area. In particular, even if the positional information PI is tampered with or the accuracy of the positional information PI is reduced due to weather information or the like, using the position determination data WD together reduces the probability of falsely determining whether the vehicle 1 is inside or outside of the specific area. The position determination data WD of a certain specific area cannot be received unless the vehicle 1 is present in the specific area, and thus, using the position determination data WD can improve the reliability of the determination that the vehicle 1 is present in the specific area.

In addition, for the determination of whether the vehicle 1 is inside or outside of the specific area, high-precision map information held by a locator may be further used, and a camera may be mounted on the vehicle 1 so as to capture images of the surrounding environment to check characteristic scenes inside or outside the specific area.

The function-enable/disable determination processor 11 determines, from the certificate data AD, what type of function change is allowed in this area and identifies the contents of a function setting change.

Thus, depending on the contents described in the certificate data AD that is provided to a user, the contents of a function setting change can be flexibly performed for each specific area, each user, or the like.

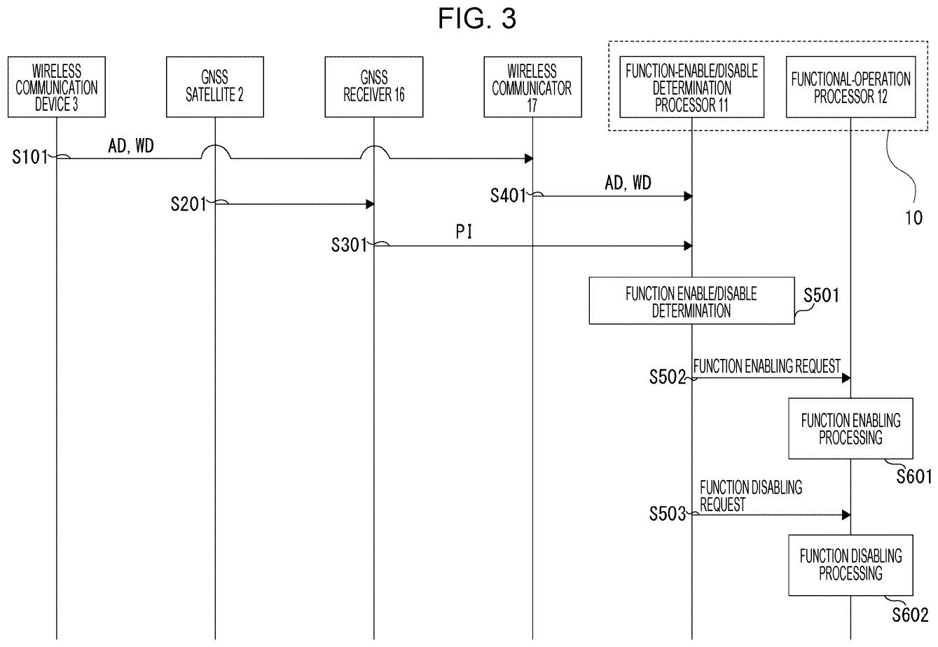

FIG. 3 schematically illustrates a process of changing a setting of a function by using each of the units illustrated in FIG. 1.

Once the vehicle 1 has entered a specific area, short-range wireless communication is performed between the wireless communicator 17 and the wireless communication device 3.

In step S101, the wireless communication device 3 transmits the certificate data AD and the position determination data WD to the wireless communicator 17 of the vehicle 1.

In step S401, the wireless communicator 17 transmits the certificate data AD and the position determination data WD to the function-enable/disable determination processor 11.

Note that the user may download the certificate data AD beforehand by accessing a website or the like of a certificate issuer from their own terminal device (a smartphone, a personal computer, or the like), and the certificate data AD may be transmitted to the vehicle-function management device 10 before entering the specific area.

In the vehicle 1, the GNSS receiver 16 successively receives radio waves from the GNSS satellite 2, and the GNSS receiver 16 successively transmits the positional information PI to the vehicle-function management device 10 (steps S201 and S301).

The function-enable/disable determination processor 11 of the vehicle-function management device 10 performs a function enable/disable determination in step S501. For example, the function-enable/disable determination processor 11 confirms, from the positional information PI and the position determination data WD, that the vehicle 1 has entered a specific area that is designated by the certificate data AD. In this case, the function that is to be subjected to a setting change and the contents of the setting change are determined on the basis of the function setting information described in the certificate data AD.

In the case of performing a setting change for enabling a certain function in accordance with the description in the certificate data AD, the function-enable/disable determination processor 11 notifies the functional-operation processor 12 of a function enabling request for the function in step S502.

In step S601, the functional-operation processor 12 performs processing of enabling the function in response to the function enabling request.

In the case of performing a setting change for disabling a certain function in accordance with the description in the certificate data AD, the function-enable/disable determination processor 11 notifies the functional-operation processor 12 of a function disabling request for the function in step S503.

In step S602, the functional-operation processor 12 performs processing of disabling the function in response to the function disabling request.

In this manner, the function-enable/disable determination processor 11 and the functional-operation processor 12 make a change to the setting of the function by using the positional information PI, the certificate data AD, and the position determination data WD received thereby.

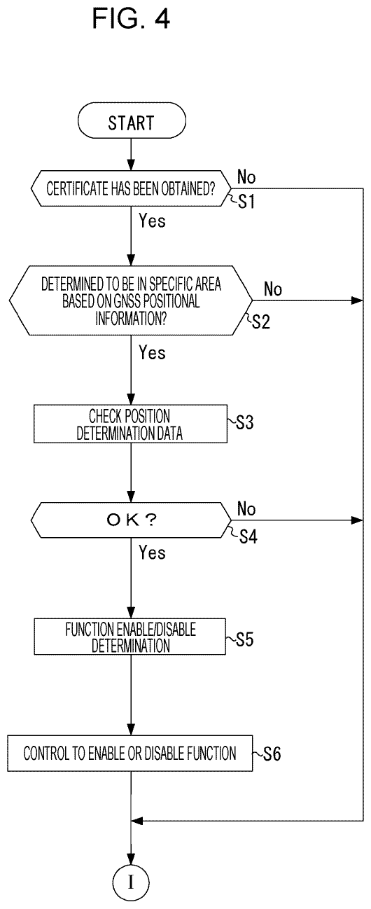

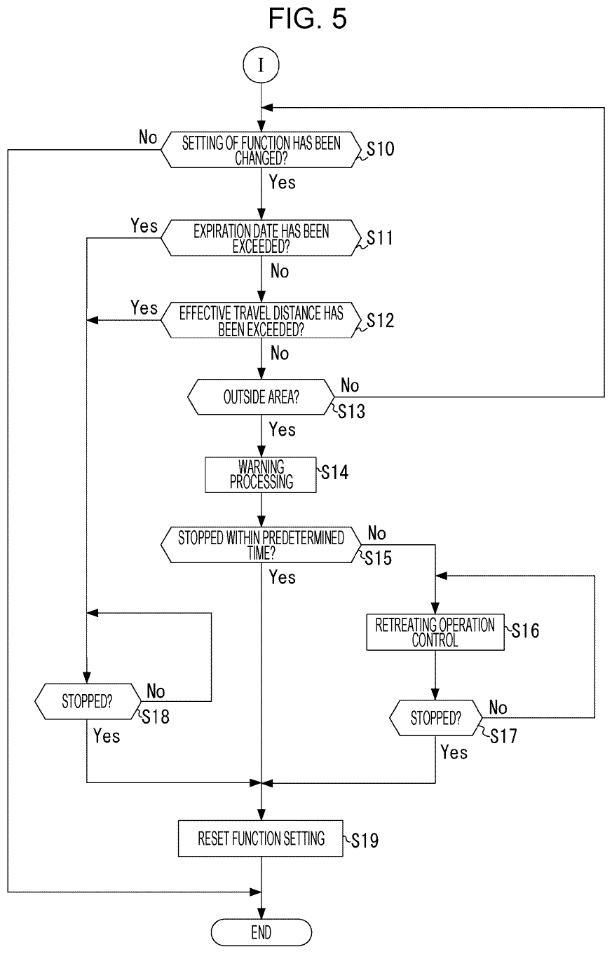

Specific examples of a process to be performed by the vehicle-function management device 10 including the function-enable/disable determination processor 11 and the functional-operation processor 12 will be described with reference to FIG. 4 and FIG. 5.

FIG. 4 illustrates an example of a process of changing a setting of a function.

In step S1, the vehicle-function management device 10 checks if the certificate data AD has been acquired. For example, there is a case where the certificate data AD is acquired by communication with the wireless communication device 3 after entering a specific area, and there is another case where the user acquires the certificate data AD beforehand through communication using the terminal device.

If the certificate data AD has already been acquired, the process proceeds to step S2.

In step S2, the vehicle-function management device 10 determines whether the vehicle 1 is present in the specific area described in the certificate data AD by referencing to the positional information PI obtained by the GNSS.

If it is determined that the vehicle 1 is present in the specific area, the vehicle-function management device 10 proceeds to step S3 and checks the position determination data WD. As a result, it is checked if the vehicle 1 is actually present in the specific area designated by the certificate data AD. Only if it is confirmed that the vehicle 1 is present in the specific area, the process proceeds from step S4 to step S5.

In step S5, the vehicle-function management device 10 performs the function enable/disable determination. This corresponds to the above-described process to be performed by the function-enable/disable determination processor 11 in steps S501, S502, and S503 illustrated in FIG. 3.

Then, in step S6, the vehicle-function management device 10 performs control so as to enable or disable the function. This corresponds to the above-described process to be performed by the functional-operation processor 12 in step S601 and S602 illustrated in FIG. 3.

In the manner described above, the setting of the function is changed in accordance with the contents described in the certificate data AD in the specific area, such as a circuit.

FIG. 5 illustrates an example of a process to be performed by the vehicle-function management device 10 in a state where the setting of the function has been changed in the specific area.

The vehicle-function management device 10 proceeds from step S10 to step S11 if the setting of the functions has been changed through the above process illustrated in FIG. 4.

In step S11, the vehicle-function management device 10 compares the expiration date information included in the certificate data AD and the current date and time and checks if the expiration date has been exceeded.

If the expiration date has been exceeded, the vehicle-function management device 10 checks if the vehicle 1 is stopped in step S18, and if it is confirmed that the vehicle 1 is stopped, the vehicle-function management device 10 proceeds to step S19 and resets the setting of the function. If it is determined in step S11 that the expiration date has not been exceeded, the vehicle-function management device 10 proceeds to step S12 and checks if an effective travel distance has been exceeded. In other words, the travel distance after the setting of the function has been changed is calculated, and the travel distance is compared with the effective-distance information described in the certificate data AD.

If the effective travel distance has been exceeded, the vehicle-function management device 10 checks if the vehicle 1 is stopped in step S18, and if it is confirmed that the vehicle 1 is stopped, the vehicle-function management device 10 proceeds to step S19 and resets the setting of the function.

If it is determined in step S12 that the effective travel distance has not been exceeded, the vehicle-function management device 10 proceeds to step S13 and determines whether the vehicle 1 is outside an area that is designated as the specific area by the certificate data AD. This determination is made on the basis of, for example, the positional information PI or whether the position determination data WD can be received again by wireless communication.

If the vehicle 1 is inside the area, the setting of the function has been properly changed at that time, and thus, the process returns to step S10 and is repeated.

If it is determined that the vehicle 1 is outside the area, warning processing for warning that the vehicle 1 is outside the area is performed in step S14. For example, processing for causing a display included in the vehicle 1 to indicate that the vehicle 1 is outside the area and prompt the vehicle 1 to stop is performed, or processing for causing a speaker included in the vehicle 1 to output a warning sound or a warning message is performed.

Then, in step S15, the vehicle-function management device 10 determines whether the vehicle 1 has been stopped within a predetermined time. If the driver stops the vehicle 1 within the predetermined time in response to a warning, the vehicle-function management device 10 proceeds to step S19 and resets the setting of the function.

In contrast, if the vehicle 1 is not stopped even after the predetermined time has elapsed, the vehicle-function management device 10 proceeds from step S15 to step S16 and performs standby operation control. For example, traveling of the vehicle 1 is switched to autonomous driving, and the vehicle 1 is caused by autonomous driving to stop at an appropriate stop position.

Then, if it is confirmed in step S17 that the vehicle 1 is stopped, the process proceeds to step S19, and the setting of the function is reset.

By performing the above processing illustrated in FIG. 5, the change made to the setting of the function is maintained only in the specific area and can be prevented from being unnecessarily maintained for a long period of time regardless of the fact that the vehicle 1 is inside or outside of the specific area. This is an appropriate processing for a setting change that is made only in a specific area such as a circuit track or a test course.

In the above-described embodiment, the following effects can be obtained.

The vehicle-function management device 10 of the embodiment performs a certificate acquisition process of acquiring the certificate data AD including the contents of a setting of a function in a specific area, a positional-information acquisition process of acquiring the positional information PI of the vehicle 1, and a position determination process of determining the position of the vehicle 1 by short-range wireless communication. In addition, when the vehicle-function management device 10 determines, on the basis of the positional-information acquisition process and the position determination process, that the vehicle 1 is located in the specific area designated by the certificate data AD, the vehicle-function management device 10 performs a function setting process of making a change to the setting of the function of the vehicle 1 in accordance with the contents of the setting of the function included in the certificate data AD.

For example, in addition to using the positional information PI obtained by the GNSS, by checking the position of the vehicle 1 by short-range wireless communication, which can be performed in a specific area, the reliability of identifying the position of the vehicle 1 can be improved. For example, even if GNSS positional information is tampered with, false determination that the vehicle 1 is in the specific area can be prevented.

In addition, by performing setting control of the function described in a certificate, the function can be appropriately enabled or disabled in the specific area.

Setting contents such as enabling or disabling of the function can be determined by the certificate data AD, and thus, the setting of the function can be flexibly changed in accordance with, for example, each specific area or each traveling opportunity.

In the embodiment, disabling of the speed limiter function, disabling of the ABS function, disabling of the steering assist function, disabling of the driving support function, enabling of the data logging function, enabling of the valet key mode, and enabling of the accelerator-map change function are performed have been mentioned as examples of the change that is made to the setting of the function of the vehicle 1. At least one of these is performed. Changes may be made to the settings of a plurality of functions.

Disabling of the speed limiter function, disabling of the ABS function, disabling of the steering assist function, disabling of the driving support function, enabling of the data logging function, the accelerator-map change function, and the like are desirable function settings in an area, such as a circuit or a test course, that is not a public road. In addition, enabling of the valet key mode is an appropriate function setting when, for example, the vehicle 1 is driven by a person who is not the driver of the vehicle 1 in a specific facility such as a hotel.

In the embodiment, a case where the certificate data AD is acquired by short-range wireless communication has been described. In a specific area such as, for example, a circuit, the certificate data AD may be acquired by short-range wireless communication, and positional information may be checked by short-range wireless communication. In this case, the user can make a change to a setting of a function without expending time and effort.

By acquiring the certificate data AD from a communication facility installed in a specific area, such as a circuit, it is possible to handle a case where the GNSS positional information is tampered with due to tampering of an in-vehicle device.

Note that, regarding the certificate data AD, for example, the user may acquire the certificate data AD beforehand from the certificate issuer by using the terminal device, such as a smartphone, and the certificate data AD may be transmitted to the vehicle-function management device 10 at any time point. In other words, the user can select beforehand a service that is desired to be used by the user and can have a certificate issued. It becomes easier for the user to use a service for changing the setting of the function.

In addition, a case has been described as an example in which, when the date and time indicated by the expiration date information included in the certificate data AD has been exceeded, the state in which the setting of the function of the vehicle 1 has been changed through the function setting process is terminated (see FIG. 5).

Instead of allowing the setting of the function to be changed indefinitely in the specific area, it is terminated on the basis of the expiration date information. This can prevent the function change in the specific area from being unnecessarily maintained.

In addition, in a case where the travel distance of the vehicle 1 in the state where the setting of the function is changed exceeds the travel distance indicated by the effective-distance information of the certificate data AD, the setting change state of the function of the vehicle 1 by the function setting process is ended (refer to FIG. 5).

Instead of allowing the setting of the function to be changed indefinitely in the specific area, it is terminated on the basis of the effective-distance information. This can prevent the function change in the specific area from being unnecessarily maintained.

Note that the process illustrated in FIG. 4 and FIG. 5 is an example. Various different process examples are also conceivable.

Although the V2I, the 5G NR base station, and the like have been mentioned above as examples of the wireless communication device 3 for acquiring the position determination data WD, the position determination accuracy can be further increased by using a plurality of these wireless communication methods.

According to the disclosure, determination of whether a vehicle is inside or outside of a specific area can be performed with high accuracy through a positional-information acquisition process and a position determination process, and a setting can be appropriately changed. In addition, a setting of a function is changed on the basis of certificate data, and thus, the setting can be flexibly changed in the specific area on the basis of the contents of the certificate data.

1. A vehicle-function management device configured to be applied to a vehicle, the vehicle-function management device comprising:
one or more processors; and
a storage medium in which a program to be executed by the one or more processors is stored,
wherein the program comprises one or more instructions, and
wherein the one or more instructions are configured to cause the one or more processors to perform
a certificate acquisition process of acquiring certificate data comprising a content of a function's setting of the vehicle in a specific area and effective-distance information regarding a change of the function's setting of the vehicle,
a positional-information acquisition process of acquiring positional information of the vehicle,
a position determination process of determining a position of the vehicle by short-range wireless communication,
a function setting process of making a change to the function's setting of the vehicle in accordance with the content of the function's setting in the certificate data when it is determined, based on the positional-information acquisition process and the position determination process, that the vehicle is in the specific area designated by the certificate data, and
a process of terminating a state in which the function's setting of the vehicle has been changed through the function setting process when a travel distance of the vehicle in a state in which the function's setting has been changed exceeds a travel distance indicated by the effective-distance information.

2. The vehicle-function management device according to claim 1,
wherein, in the function setting process, as the change that is made to the function's setting of the vehicle, one or more of disabling of a speed limiter function, disabling of an ABS function, disabling of a steering assist function, disabling of a driving support function, enabling of a data logging function, enabling of a valet key mode, and enabling of an accelerator-map change function are performed.

3. The vehicle-function management device according to claim 1,
wherein, in the certificate acquisition process, the certificate data is acquired by the short-range wireless communication.

4. The vehicle-function management device according to claim 1,
wherein the certificate data comprises expiration date information regarding the change of the function's setting of the vehicle, and
wherein the one or more instructions are configured to cause the one or more processors to terminate the state in which the function's setting of the vehicle has been changed through the function setting process when a date and time indicated by the expiration date information has been exceeded.

5. The vehicle-function management device according to claim 2,
wherein the certificate data comprises expiration date information regarding the change of the function's setting of the vehicle, and
wherein the one or more instructions are configured to cause the one or more processors to terminate the state in which the function's setting of the vehicle has been changed through the function setting process when a date and time indicated by the expiration date information has been exceeded.

6. The vehicle-function management device according to claim 3,
wherein the certificate data comprises expiration date information regarding the change of the function's setting of the vehicle, and
wherein the one or more instructions are configured to cause the one or more processors to terminate the state in which the function's setting of the vehicle has been changed through the function setting process when a date and time indicated by the expiration date information has been exceeded.
